(19) United States
(12) Patent Application Publication
(10) Pub. No.: US 2015/0201666 A1
(43) Pub. Date: Jul. 23, 2015

(54) EXTRACTOR FOR PRODUCING ENHANCED QUALITY PULP AND ASSOCIATED METHODS

(71) Applicant: JOHN BEAN TECHNOLOGIES CORPORATION, Chicago, IL (US)

(72) Inventors: João Roberto AMADOR, Lakeland, FL (US); Gregory W. SCHRADER, Lakeland, FL (US)

(73) Assignee: JOHN BEAN TECHNOLOGIES CORPORATION, Chicago, IL (US)

(21) Appl. No.: 14/157,645

(22) Filed: Jan. 17, 2014

(51) Int. Cl. A23N 1/00; B01D 29/11; B01D 29/23

(52) U.S. Cl. CPC A23N 1/003; B01D 29/23; B01D 29/111

(57) ABSTRACT

An extractor may include first and second cups being relatively moveable for compressing a fruit therebetween during extraction. A first cutter is associated with the first cup and includes a first cutter base having at least one base opening therein, and a first cutting blade extending outwardly from the first cutter base to define an interior passageway in communication with the at least one base opening. In other words, the extractor may include a windowed cutter. The extractor may also include a strainer tube coupled to the second cup and having longitudinally extending, slotted openings therein. The slotted openings may each have a width in a range of 0.03 to 0.05 inches, or more preferably, 0.035 to 0.045 inches. The strainer tube may be used without the windowed cutter.

### FIELD OF THE INVENTION

This invention relates to fruit processing, and, more particularly, to a system and method for processing fruit to control pulp quality.

### BACKGROUND OF THE INVENTION

Citrus pulp is a type of fruit pulp. Citrus pulp is separated from juice typically by processing the citrus pulp in a juice extractor, which strains out most of the seeds and membranes through a strainer tube to produce a citrus pulp and juice product. This juice product is typically further processed at a juice finisher for separating citrus pulp from the juice.

It may be desirable in some cases to produce a larger pulp sack in a premium pulp system by recovering pulp sacks that are more intact. For example, this citrus pulp can be added back to the juice to form a final product, e.g., a pulpy orange juice, or the citrus pulp can be collected separately, cleaned and pasteurized, and shipped to customers that package their own juice or juice-based product, or sell citrus pulp wholesale.

FMC, the predecessor to the assignee of the present invention, John Bean Technologies Corporation, offered a citrus juice and pulp extractor including first and second cups being relatively moveable for compressing a fruit therebetween during extraction. The extractor included a first cutter associated with the first cup, and a second cutter associated with the second cup. In addition, the extractor included a strainer tube coupled to the second cup to receive pulp and juice therein. As described in U.S. Pat. No. 4,376,409 the strainer tube included two sets of different sized round holes in the strainer tube. The holes closer to the upper end of the strainer tube being smaller than the holes closer to the lower end of the tube. The larger holes were typically sized at 0.060 inches but are described as being as large as 0.125 inches.

In some commercially used FMC extractors, the strainer tube had a plurality of relatively large slotted openings. In particular, the strainer tube had an overall length of 10.37 inches and included four groups of longitudinally extending slotted openings in a smooth wall tube having an outer diameter of 1.176 inches. Each group included ten equally spaced slotted openings. Each slotted opening also had a width of 0.125 inches. The slotted openings closer to the upper end had a length of 0.75 inches. The other three groups of slotted openings had a length of 1.188 inches. Although larger sized pulp was produced, this strainer tube also produced a relatively large amount of defects, especially core and membrane material which required additional processing to remove, and which produced juice being more bitter than desired.

A typical current extractor includes a strainer tube with a plurality of round openings. Each round opening actually has two diameters, with a smaller diameter being radially innermost. This diameter is 0.062 inches.

Attempts have been made to reduce defects downstream from the extractor. For example, U.S. Pat. No. 6,727,452 assigned to the assignee of the present invention, discloses a system and method that removes defects from citrus pulp. An advancing mechanism advances citrus pulp along a predetermined path of travel into an inspection zone. A citrus pulp imager is positioned at the inspection zone and acquires image data of the citrus pulp. A processor is connected to the citrus pulp imager and receives the image data and processes the image data to determine defects within the citrus pulp. A rejection mechanism rejects the flow of citrus pulp determined to be defective.

There is still a desire to produce larger pulp pieces with a reduced quantity of defects in the pulp.

### SUMMARY OF THE INVENTION

In view of the foregoing background, it is therefore an object of the invention to provide an extractor and associated methods that enhances pulp quality in terms of larger pulp size and/or a reduced number of defects.

These and other objects, features and advantages are provided by an extractor comprising first and second cups being relatively moveable for compressing a fruit therebetween, and a first cutter associated with the first cup and comprising a first cutter base having at least one base opening therein. A first cutting blade extends outwardly from the first cutter base to define an interior passageway in communication with the at least one base opening. In other words, the extractor may include a windowed cutter. Moreover, the extractor may also include a strainer tube coupled to the second cup and having a plurality of slotted openings to produce fruit pulp and juice. The combination of the windowed cutter with the slotted opening strainer tube may significantly improve the quality of extracted pulp.

The slotted openings may extend longitudinally, for example. The slotted openings may each have a width in a range of 0.03 to 0.05 inches, and, more preferably between 0.035 to 0.045 inches. The slotted openings may each have a length in a range of 0.7 to 1.5 inches in some embodiments. In addition, the slotted openings may be arranged in a plurality of longitudinally spaced groups.

The strainer tube may comprise a tubular body and a plurality of spaced apart reinforcement rings coupled to the tubular body. The reinforcement rings serve to reinforce the tubular body for strength and durability.

The first cutter may comprise a core extending outwardly from the first cutter base and positioned within the first cutting blade in spaced relation therefrom. The at least one base opening may open outwardly to a periphery defined by adjacent base portions.

In some embodiments, the second cup may comprise a ring base defining a second cup bore, and a plurality of fingers extending outwardly from the ring base. The extractor may further comprise a second cutter including a second cutting blade sized to be received within the interior passageway of the first cutter, and a flange extending outwardly from the second cutting blade and mounting the second cutter in the second cup bore. The flange may be at a level flush with or above adjacent portions of the ring base. This arrangement also helps reduce defects in the pulp.

In some embodiments of the extractor, the strainer tube as described may be used alone without the windowed cutter, or the modified second cup and second cutter.

The extractor may also include at least one juice finisher downstream from the strainer tube. Of course, other storage tanks, etc. may also be coupled downstream from the strainer tube.

A method aspect is for making a strainer tube for an extractor for fruit, the extractor comprising first and second cups being relatively moveable for compressing a fruit therebetween. The method may comprise forming a tubular body having a first end to be coupled to the second cup, with the tubular body having a plurality of longitudinally extending, slotted openings to produce fruit pulp and juice therethrough, and with each slotted opening having a width in a range of 0.035 to 0.045 inches.

### BRIEF DESCRIPTION OF THE DRAWINGS

FIG. 1 is a cross-sectional and partial schematic view of portions of a juice extractor prior to compressing the fruit and including downstream processing devices according to the present invention.

FIG. 2 is a cross-sectional view of a portion of the juice extractor of FIG. 1 during compression of the fruit.

FIG. 3 is a side elevational view of another embodiment of a strainer tube as may be used in the extractor of FIGS. 1 and 2.

FIG. 4 is a cross-sectional view taken along lines 4-4 of FIG. 3.

FIG. 5 is an enlarged perspective view of the first cutter of the juice extractor of FIG. 1.

FIG. 6 is an enlarged partial side elevation view of the first cutter of the extractor of FIG. 1.

FIG. 7 is a top plan view of the second cup of the juice extractor illustrated in FIG. 1.

FIG. 8 is a cross-sectional view of the second cup and second cutter associated therewith of the juice extractor illustrated in FIG. 1.

FIG. 9 is an enlarged side elevation view of first and second cutters of the juice extractor illustrated in FIG. 1.

FIG. 10 is a cross-sectional view of the first and second cutting blades as shown in FIG. 9 with various dimensions marked for clarity of explanation.

FIG. 11 is a bar chart of relative percentages of different sized pulp from the extractor according to the invention compared to a prior art extractor.

FIG. 12 is a graph plotting data points relating to defects for the extractor according to the invention prior art extractor.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

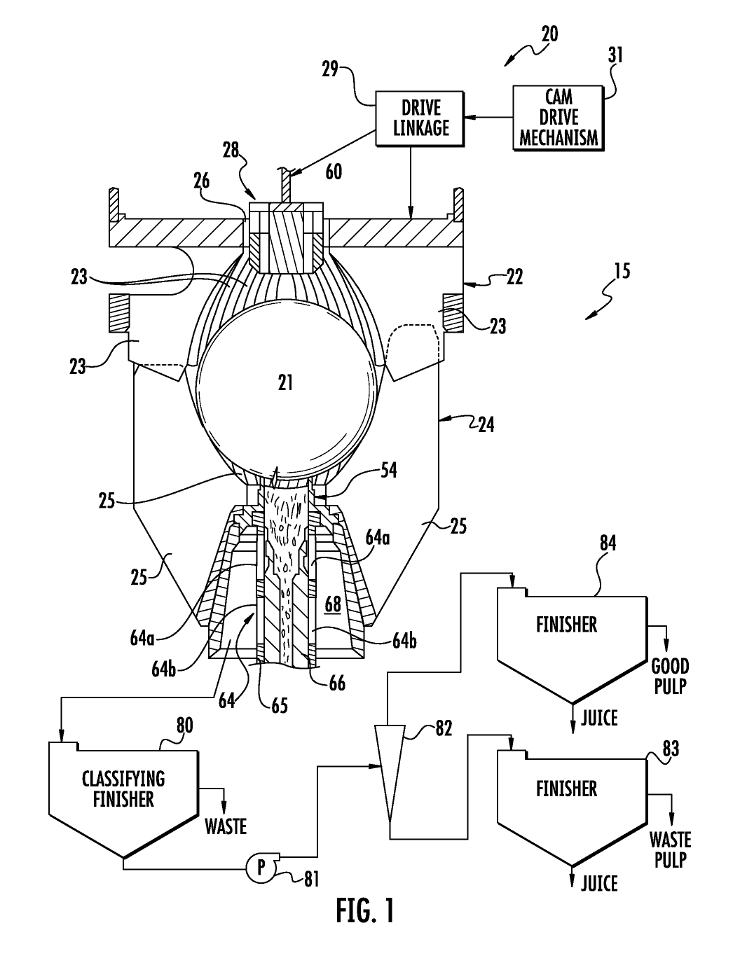

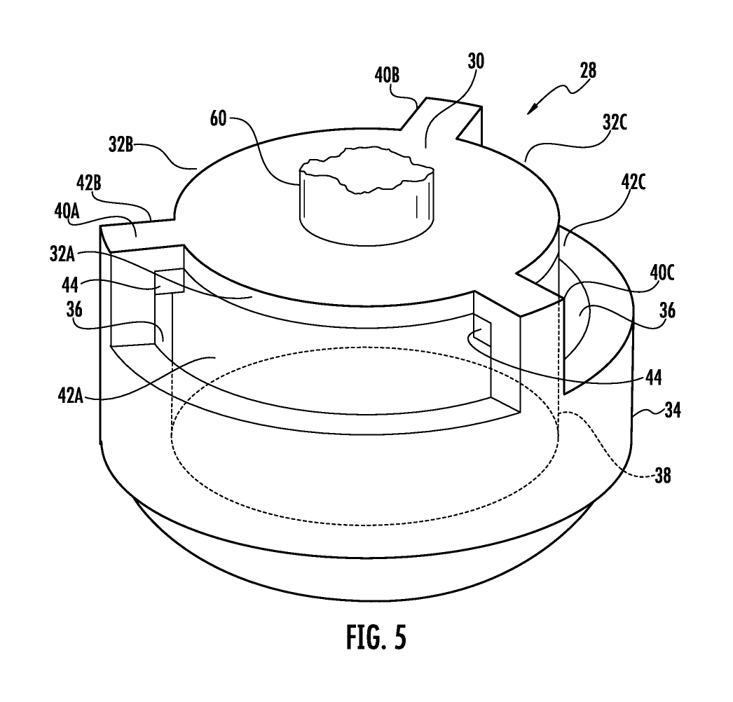

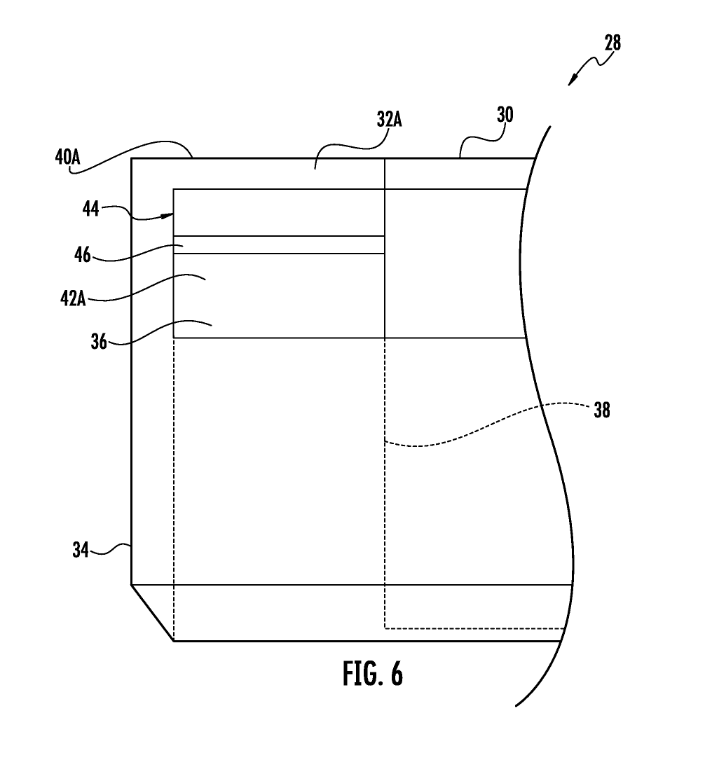

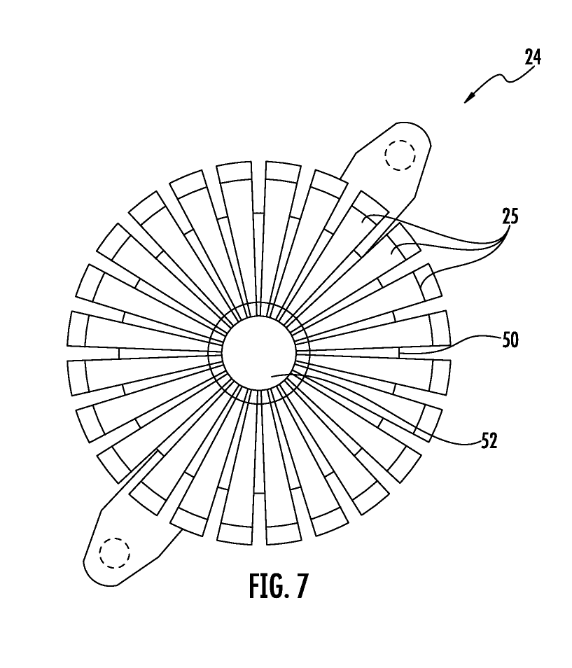

Referring initially to FIGS. 1-2 and 5-6, a juice extractor system 15 according to the present invention is described. The juice extractor system 15 includes a juice extractor 20 that, in turn, illustratively includes first and second cups 22, 24 between which a fruit 21 (e.g., orange, grapefruit, etc.) may be held. With the fruit therebetween, the first and second cups 22, 24 come together by moving relative to one another illustratively along a substantially linear reciprocal path of travel, for example. The fruit peel is separated and the internal portions of the fruit are extracted as the first and second cups 22, 24 come together thereby compressing the fruit 21 as will be readily understood by those skilled in the art. The fruit is held in the second cup 24 with the first cup 22 illustratively descending downwardly from above the second cup 24 and onto the fruit 21.

Illustratively, a cam drive mechanism 31 connected to the first cup 22 by a drive linkage 29 drives the first cup linearly downward. As will be readily appreciated by those skilled in the art, other orientations of the first and second cups 22, 24, as well as other mechanisms for moving them relative to one another may alternately be used. For example, the first and second cups 22, 24 may be oriented in the same horizontal plane, and each may move toward the other in a horizontal direction driven by one of various drive mechanisms known to those skilled in the art.

As further illustrated, the first cup 22 comprises a first plurality of fingers 23, and the second cup 24 comprises a second plurality of fingers 25. Both pluralities of fingers 23, 25 extend outwardly to intermesh and compress the fruit 21 as the respective cups 22, 24 are moved together. Illustratively, the first plurality of fingers 23 extends radially outwardly to define a first cup bore 26.

A first cutter 28 is received within the first cup bore 26 such that it is positioned within a top portion of the first cup 22. The first cutter 28 cuts a plug in a top portion of the fruit 21 to permit a separation of the fruit peel from interior portions of the fruit. As will be readily understood by those skilled in the art, this helps prevent the fruit 21 from bursting as it is squeezed between the respective pluralities of fingers 23, 25 of the first and second cups 22, 24.

The first cutter 28 illustratively comprises a first cutter base 30 having three base openings 32A, 32B, 32C. As will be readily appreciated by those skilled in the art, the first cutter 28 may alternately have more than three base openings or it may have as few as one. The first cutter 28 further has a first cutting blade 34 extending outwardly from the first cutter base 30. Illustratively, the first cutting blade 34 has a cylindrical shape and a beveled cutting edge. The first cutting blade 34, in extending outwardly from the first cutter base 30, defines an interior passageway 36. The interior passageway 36, as shown, is in communication with the base openings 32A, 32B, 32C and thus permits the release of debris therethrough.

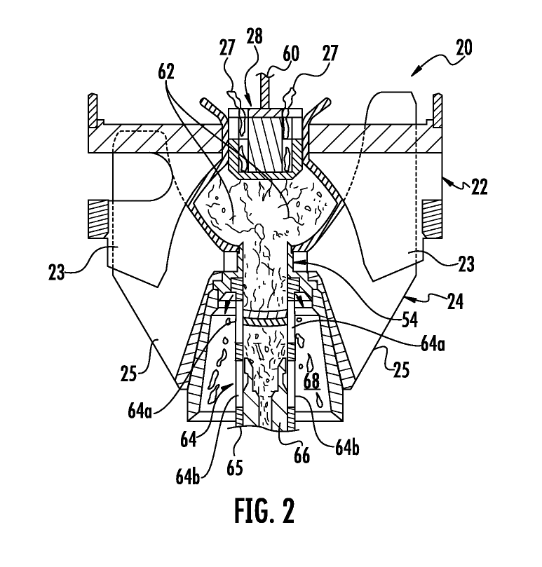

The interior passageway 36, through which debris such as fruit peel is ejected or released, lends the first cutter 28 distinct advantages over typically used cutters having no or only side openings. In contrast to conventional cutters, when the first cutter 28 cuts into the fruit 21, the fruit peel and other debris is much less likely to become trapped or wedged therein. Instead, under the pressure that results as the first and second cups 22, 24 come together squeezing the fruit 21 therebetween, the debris is pushed along and out the interior passageway 36. Specifically, if the first cup 22 is oriented above the second cup 24 and descends onto the fruit 21, the resulting pressure forces the debris upwardly and out from the first cutter 28 (as indicated by the arrows 27 in FIG. 2).

Illustratively, each of the base openings 32A, 32B, 32C of the first cutter 28 opens outwardly to a periphery defined by adjacent base portions 40A, 40B, 40C. This accordingly enhances the release of debris through the interior passageway 36. Additionally, the first cutting blade 34 has three blade openings 42A, 42B, 42C therein. Moreover, each blade opening 42A, 42B, 42C is illustratively in communication with a respective one of the three base openings 32A, 32B, 32C thus further enhancing the release of debris through the interior passageway 36.

Optionally, the first cutter 28 may include a core 38 that extends outwardly from the first cutter base 30 so that the core is positioned within the first cutting blade 34. As shown, the optionally included core 38 within the first cutting blade 32 is in a spaced relation from the first cutting blade.

Additionally, the first cutter 28 may optionally include debris deflectors 44 adjacent the first cutter base 30. As illustrated, each debris deflector 44 has a pointed edge 46 directed toward the interior passageway 36. A blade opening 42A in communication with a base opening 32A defines an L-shaped support leg that connects together the first cutter base 30 and the first cutting blade 34. The debris deflector 44 is illustratively adjacent an inner portion of an L-shaped support leg as shown.

The fruit 21 is squeezed as the cam drive mechanism 31 drives the first cup 22 together with the second cup 24. The first cutter 28 cuts a top plug in the fruit as the first cup 22 moves against the fruit 21. The fruit 21 is also forced against the second cutting blade 56, which cuts a bottom plug into a bottom portion of the fruit 21. As a result of increasing pressure during the extraction process, the internal portions 62 of the fruit 21 are forced through the bottom portion plug and into a strainer (or prefinisher) tube 64. Separated fruit peel is discharged between the first cup 22 and the first cutter 28. As detailed above, any fruit peel or debris within the first cutter 28 is released through the interior passageway 36.

A shaft 60 illustratively extends outwardly from the first cutter base 30 opposite the first cutting blade 34. The shaft 60 may secure the first cutter 28 to the drive linkage 29 connected to the cam drive mechanism 31 that illustratively drives the first cup 22 down onto the fruit 21 during juice extraction. This first cutter 28 may be referred to as a windowed cutter in that it has windows to permit debris to be ejected therethrough.

As the internal portions 62 of the fruit 21 are extracted, they move into the strainer tube 64. When extraction is complete, an orifice tube 66 moves upward from below the strainer tube 64 creating pressure on the contents therein, which causes extracted juice and pulp to flow out through the slotted openings 64a, 64b in the tubular body 65 of the strainer tube and into a juice manifold 68. The release of fruit peel and other debris through the internal passageway 36 and its deflection by the flange 58 prevents the debris from mixing with the internal portions of the fruit 21. Accordingly, the quality of the extracted juice is higher.

The slotted openings 64a, 64b extend longitudinally, as shown in the illustrated embodiment. This longitudinal arrangement is in contrast to slotted openings as disclosed in U.S. Pat. No. 6,293,189 which discloses circumferential extending slotted openings. The circumferential slotted openings are believed to serve a grating function and create more defects while also likely damaging the pulp.

The slotted openings 64a, 64b may each have a width in a range of 0.03 to 0.05 inches, and, more preferably between 0.035 to 0.045 inches. For example, the width may be 0.040 inches. The slotted openings 64a, 64b may each have a length in a range of 0.7 to 1.5 inches in some embodiments. For example, the length may be 1.102 inches. The slotted openings 64a, 64b may be arranged in a plurality of longitudinally spaced groups as shown in the illustrated embodiment of FIGS. 1 and 2.

As shown with specific reference to FIG. 1, the illustrated embodiment of the extractor system 15 includes a classifying finisher 80 coupled to the manifold 68 and it produces a waste, as well as a fruit juice and pulp stream. The fruit pulp and juice is pumped, via pump 81, to a cyclone separator 82. The upper output of the cyclone separator 82 is delivered to another finisher 84 which, in turn, produces the good or usable fruit pulp, as well as the fruit juice, as will be appreciated by those of skill in the art. In addition, another finisher 83 processes the material from the lower output of the cyclone separator 82 to produce a juice stream as well as waste pulp.

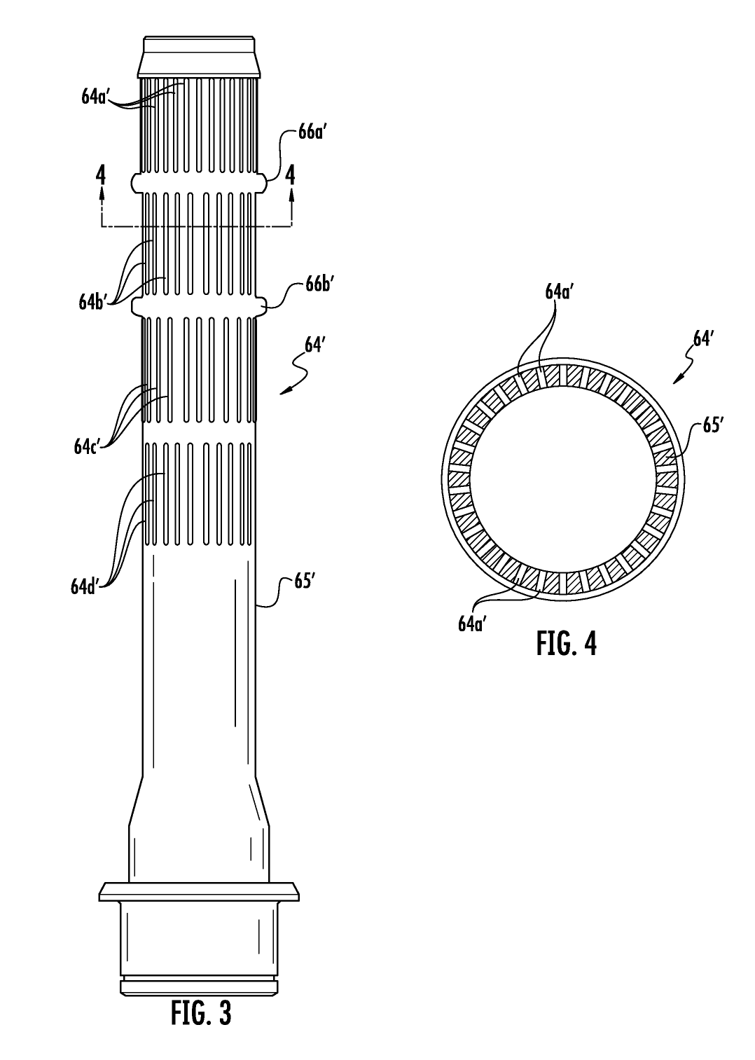

With additional reference to FIGS. 3 and 4, another embodiment of a strainer tube 64′ is now described, The strainer tube 64′ includes a tubular body 65′ and a plurality of spaced apart reinforcement rings 66a′, 66b′ coupled to the tubular body adjacent the upper end. The rings 66a′, 66b′ serve to reinforce the tubular body against higher pressures likely to be experienced at the upper end to thereby provide greater longevity and durability. Of course, in other embodiments, more than two reinforcement rings 66a′, 66b′ could be provided as will be appreciated by those skilled in the art.

The slotted openings 64a′, 64b′, 64c′, 64d′ may have the dimensions as described above with respect to the strainer tube 64 shown in FIGS. 1 and 2. In this embodiment, there are 30 slotted openings in each group, and successive groups are rotationally offset from one another. The outer diameter of the tubular body 65′ may be 1.176 inches. In addition, the uppermost slotted openings 64a′ may have a slightly shorter length, e.g. 1.000 inches, as compared to the other slotted openings 64b′, 64c′, 64d′ which may have a length of 1.102 inches as noted above.

The combination of the windowed cutter 28 with the slotted opening strainer tube 64, 64′ may significantly improve the quality of extracted pulp in terms of reduced defects and an increase in the size of the extracted pulp. In some embodiments, the extractor 20 may only include the slotted opening strainer tube 64, 64′ and may still achieve an acceptable increase in pulp quality as will be appreciated by those skilled in the art.

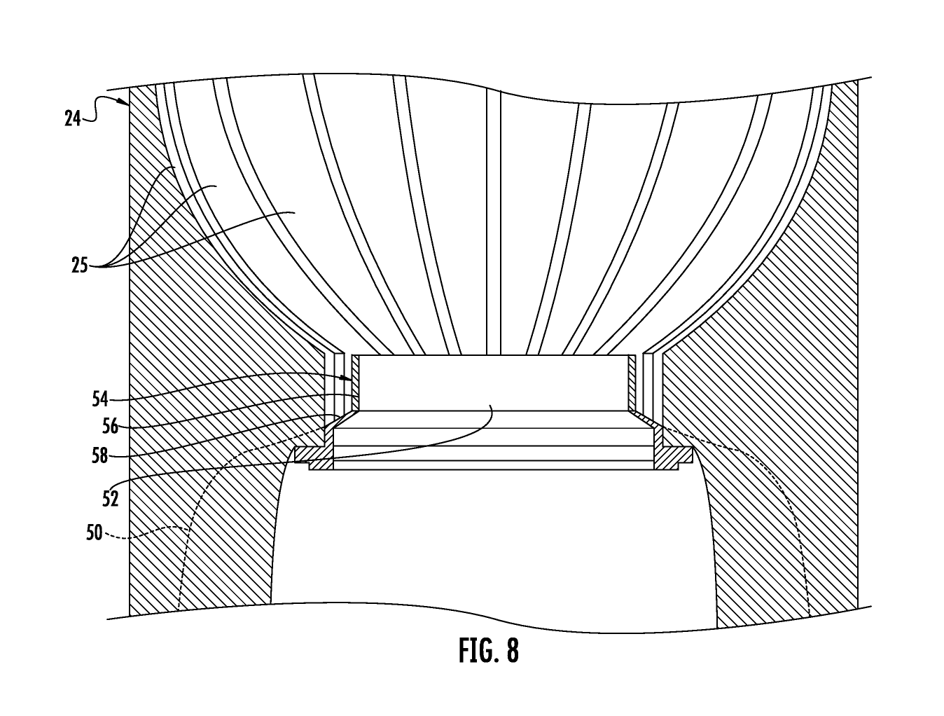

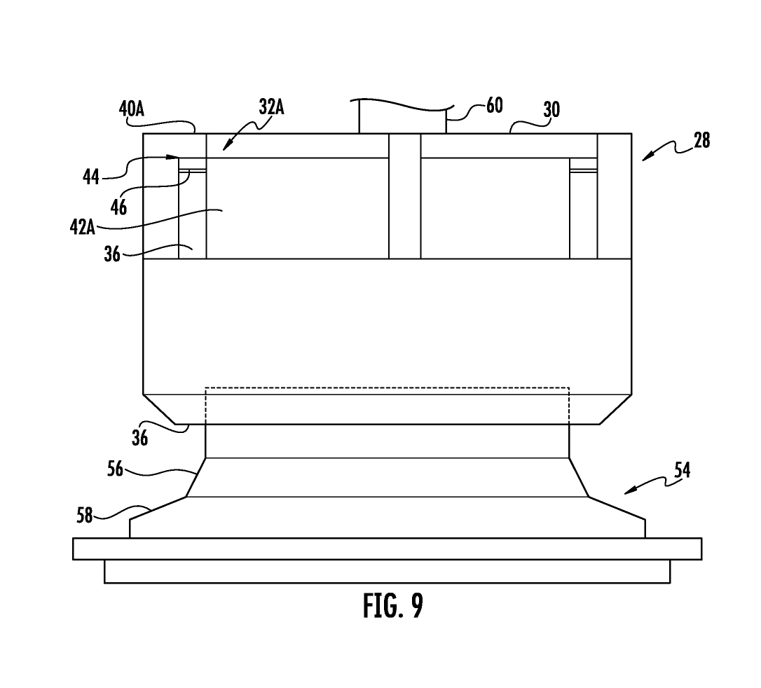

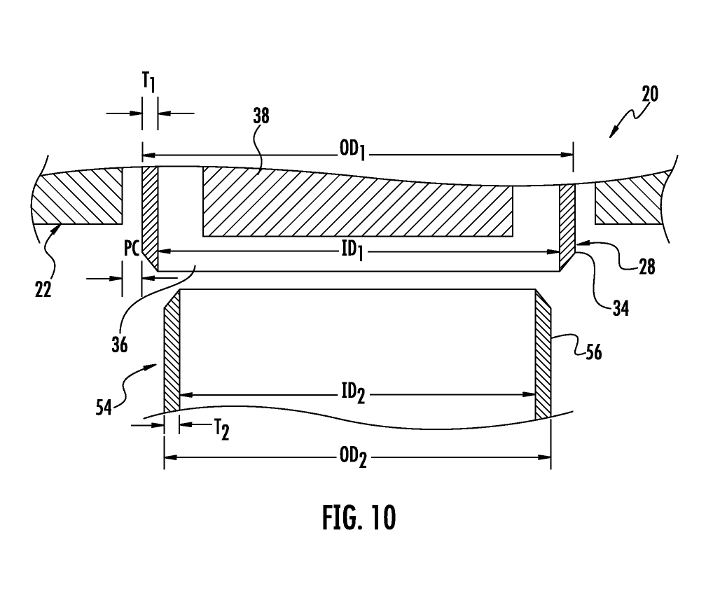

Referring additionally now to FIGS. 7-10, another aspect of the juice extractor 20 relative to quality and yield is now described. The second cup 24 illustratively comprises a ring base 50 defining a second cup bore 52. The second plurality of fingers 25 extends outwardly from the ring base 50. Illustratively, the second cup 24 further mounts a second cutter 54 within the second cup bore 52. The second cutter 54 illustratively includes a second cutting blade 56. As perhaps best shown in FIG. 10, the second cutting blade 56 is sized so that it can be received within the interior passageway 36 of the first cutter 28.

As also illustrated, a flange 58 extends outwardly from the second cutting blade 56 to mount the second cutter 54 in the second cup bore 52. The flange 58 is illustratively at a level flush with adjacent portions of the ring base 50. As will be readily understood by those skilled in the art the flange 58 may also be at a level above the ring base 50. The flange 58 serves to prevent cut and separated fruit peel, including the peel ring resulting from the cutting of plugs in the fruit 21, from becoming mixed in with the internal portions squeezed from the fruit by the first and second cups 22, 24. Accordingly, without reducing juice yield, the flange 58 enhances juice quality by lessening the amount of peel oil that would otherwise be added to the juice during squeezing. The optionally included debris deflectors 44, illustratively having pointed edges 46, may cooperate with the flange 58 by further segmenting the fruit peel and deflecting it away from the first and second cutters 22, 24 and, hence, away from the internal portions of the fruit 21. Again, the deflection of the peel ring away from the internal portions squeezed from the fruit 21 reduces the amount of peel oil in the juice ultimately produced, thereby enhancing juice quality without reducing juice yield.

The first cylindrical cutting blade 34 may have an inner diameter ID1, an outer diameter OD1, and a wall thickness T1. The second cylindrical cutting blade 56 may have an outer diameter OD2 to be received within the inner diameter ID1 of the first cylindrical cutting blade 34, an inner diameter ID2 and a wall thickness T2. The particular component sizes may be selected to produce a desired relatively high yield and juice quality. The peel clearance PC may be in a range suitable for oranges, for example. Of course, other values of peel clearance may also be used as will be appreciated by those skilled in the art. The spacing of adjacent finger portions of the second cup from the second cutter may be in the conventional range. In addition, the strainer tube 64 and orifice tube 66 as described above may also be sized appropriately for the second cutter 56 as will be readily appreciated by those skilled in the art without requiring further discussion.

Applicants have now recognized unexpected improvements in pulp size and reduced defects by use of the slotted opening strainer tube 64, 64′, either alone, or in combination with one or both of the windowed cutter 28, and modifications to the second cutter 54 and second cup 24. It is noted that the windowed cutter 28 and modifications to the second cutter 54 and second cup 24 are disclosed in U.S. Pat. Nos. 6,805,043 and 6,923,112, assigned to the present assignee and the contents of which are incorporated by reference herein in their entireties. The '043 and '112 patents are directed to improving juice quality while maintaining a relatively high juice yield by reducing pieces of fruit peel that, in turn, introduce peel oil into the extracted juice.

The use of the slotted opening strainer tube 64, 64′ in combination with the windowed cutter 28 and other modifications described herein advantageously results in less peel defects, provides an increase in pulp size, provides parity or better finished juice yield, provides parity with or better pulp yield, and provides parity with or better finished juice quality.

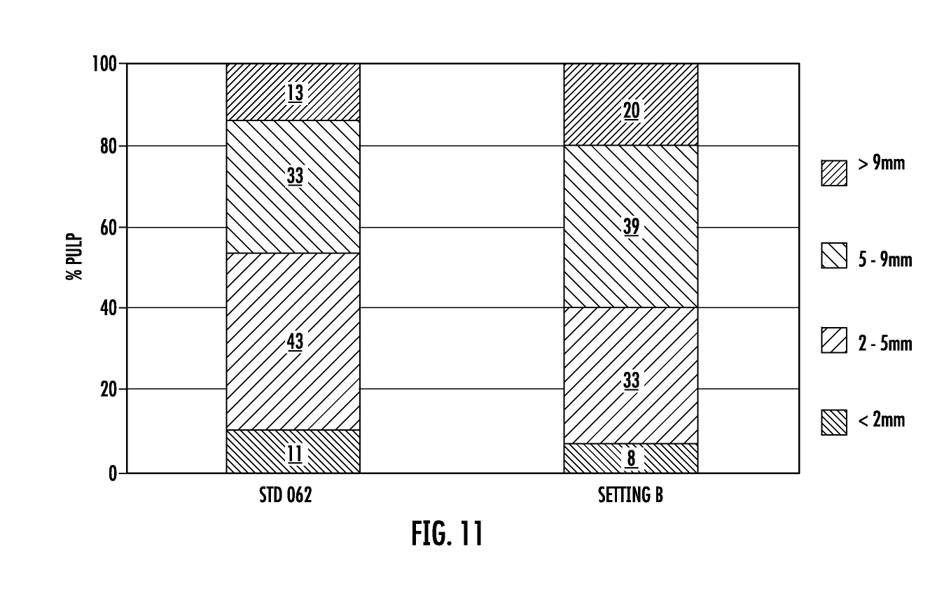

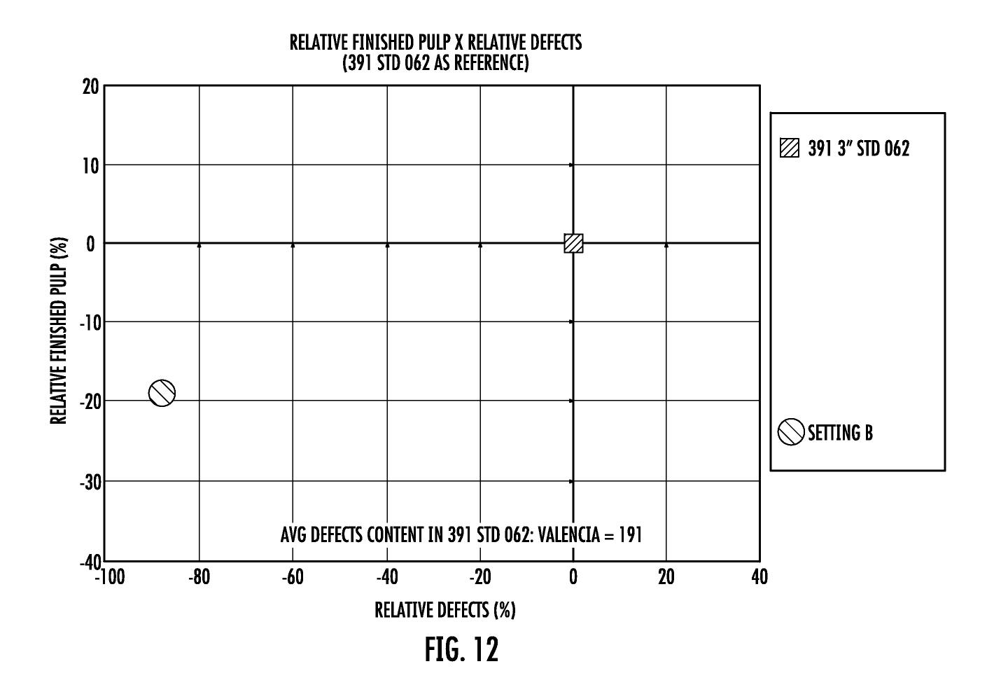

Turning now to the bar chart graph of FIG. 11, a comparison of the distribution of pulp sizes between a standard extractor (STD 062) and the extractor as described herein (Setting B) illustrates that a higher percentage of the pulp is in a size range of greater than 9 mm for an example using Valencia oranges. The STD 062 extractor includes a typical strainer as described in the background having round openings of a diameter of 0.062 inches, and without the windowed cutter, the slotted openings or modifications to the second cup and second cutter as in the embodiment labeled Setting B.

In particular, the percentage of pulp having a largest dimension greater than 9 mm for the Setting B extractor is 20%, while the STD 062 extractor produces only 13% of such desirable pulp sizes. The percentage of pulp in the range of 5-9 mm is 39% for the Setting B extractor and 33% for the STD 062 extractor; the percentage of pulp sizes 2-5 mm is 33% for the Setting B extractor and 43% for the STD 062 extractor; and the percentage of pulp less than 2 mm is 8% for the Setting B extractor and 11% for the STD 062 extractor. Accordingly, it can be seen that for the most desirable pulp size, i.e. greater than 9 mm, the Setting B extractor provides a significant advantage of 20% of the pulp falling within this desirable range versus only 13% of the pulp for the STD 062 extractor.

Turning now to FIG. 12, a pair of data points is plotted as pertaining to a percentage of relative pulp yield and relative defects in the pulp for Valencia oranges. The origin or reference is for the labeled 391 3″ STD 062 prior art extractor as described above, and wherein its defect count is 191. The data point for the Setting B extractor shows a significant decrease in defects (reduced by 84%), and as a tradeoff, also shows a reduction in the overall amount of finished pulp (reduced 19%). Accordingly, it can be seen that the developments disclosed herein, particularly, the slotted opening strainer tube, alone or in combination with the other features disclosed herein, provides a significant reduction in the number of defects (FIG. 12), and also provides an increase in the percentage of pulp having a larger, more desirable, size (FIG. 11).

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. An extractor for fruit comprising:
first and second cups being relatively moveable for compressing a fruit therebetween;
a first cutter associated with said first cup and comprising
a first cutter base having at least one base opening therein, and
a first cutting blade extending outwardly from said first cutter base to define an interior passageway in communication with the at least one base opening; and
a strainer tube coupled to said second cup and having a plurality of slotted openings to produce fruit pulp and juice therethrough.

2. The extractor according to claim 1 wherein the plurality of slotted openings extend longitudinally.

3. The extractor according to claim 1 wherein the plurality of slotted openings each has a width in a range of 0.03 to 0.05 inches.

4. The extractor according to claim 1 wherein the plurality of slotted openings each has a width in a range of 0.035 to 0.045 inches.

5. The extractor according to claim 1 wherein the plurality of slotted openings each has a length in a range of 0.7 to 1.5 inches.

6. The extractor according to claim 1 wherein the plurality of slotted openings are arranged in a plurality of longitudinally spaced groups.

7. The extractor according to claim 1 wherein said strainer tube comprises a tubular body and a plurality of spaced apart reinforcement rings coupled to said tubular body.

8. The extractor according to claim 1 wherein said first cutter further comprises a core extending outwardly from said first cutter base and positioned within said first cutting blade in spaced relation therefrom.

9. The extractor according to claim 1 wherein the at least one base opening opens outwardly to a periphery defined by adjacent base portions.

10. The extractor according to claim 1 wherein said second cup comprises a ring base defining a second cup bore, and a plurality of fingers extending outwardly from said ring base; and further comprising a second cutter including a second cutting blade sized to be received within the interior passageway of said first cutter, and a flange extending outwardly from said second cutting blade and mounting said second cutter in the second cup bore.

11. The extractor according to claim 10 wherein said flange is at a level flush with or above adjacent portions of said ring base.

12. The extractor according to claim 1 further comprising at least one juice finisher downstream from said strainer tube.

13. An extractor for fruit comprising:
first and second cups being relatively moveable for compressing a fruit therebetween; and
a strainer tube coupled to said second cup and having a plurality of longitudinally extending, slotted openings to produce fruit pulp and juice therethrough, each slotted opening having a width in a range of 0.035 to 0.045 inches.

14. The extractor according to claim 13 wherein the plurality of longitudinally extending, slotted openings each has a length in a range of 0.7 to 1.5 inches.

15. The extractor according to claim 13 wherein the plurality of longitudinally extending, slotted openings are arranged in a plurality of longitudinally spaced groups.

16. The extractor according to claim 13 wherein said strainer tube comprises a tubular body and a plurality of spaced apart reinforcement rings coupled to said tubular body.

17. The extractor according to claim 13 further comprising a first cutter associated with said first cup and comprising:
a first cutter base having at least one base opening therein; and
a first cutting blade extending outwardly from said first cutter base to define an interior passageway in communication with the at least one base opening.

18. The extractor according to claim 17 wherein said second cup comprises a ring base defining a second cup bore, and a plurality of fingers extending outwardly from said ring base; and further comprising a second cutter including a second cutting blade sized to be received within the interior passageway of said first cutter, and a flange extending outwardly from said second cutting blade and mounting said second cutter in the second cup bore.

19. The extractor according to claim 18 wherein said flange is at a level flush with or above adjacent portions of said ring base.

20. A strainer tube for an extractor for fruit, the extractor comprising first and second cups being relatively moveable for compressing a fruit therebetween, the strainer tube comprising:
a tubular body having a first end to be coupled to the second cup, said tubular body having a plurality of longitudinally extending, slotted openings to produce fruit pulp and juice therethrough, with each slotted opening having a width in a range of 0.035 to 0.045 inches.

21. The strainer tube according to claim 20 wherein the plurality of longitudinally extending, slotted openings each has a length in a range of 0.7 to 1.5 inches.

22. The strainer tube according to claim 20 wherein the plurality of longitudinally extending, slotted openings are arranged in a plurality of longitudinally spaced groups.

23. The strainer tube according to claim 21 further comprising a plurality of spaced apart reinforcement rings coupled to said tubular body.

24. A method for making a strainer tube for an extractor for fruit, the extractor comprising first and second cups being relatively moveable for compressing a fruit therebetween, the method comprising:
forming a tubular body having a first end to be coupled to the second cup, the tubular body having a plurality of longitudinally extending, slotted openings to produce fruit pulp and juice therethrough, with each slotted opening having a width in a range of 0.035 to 0.045 inches.

25. The method according to claim 24 wherein the plurality of longitudinally extending, slotted openings each has a length in a range of 0.7 to 1.5 inches.

26. The method according to claim 24 wherein the plurality of longitudinally extending, slotted openings are arranged in a plurality of longitudinally spaced groups.

27. The method according to claim 24 further comprising forming a plurality of spaced apart reinforcement rings coupled to the tubular body.
